(19) United States
(12) Patent Application Publication
(10) Pub. No.: US 2025/0311693 A1
(43) Pub. Date: Oct. 9, 2025

(54) PET CARRIER SYSTEM FOR AIRCRAFT

(71) Applicant: Marilyn Ariosa, Jarvis (CA)

(72) Inventor: Marilyn Ariosa, Jarvis (CA)

(21) Appl. No.: 18/630,201

(22) Filed: Apr. 9, 2024

(51) Int. Cl. A01K 1/02; A01K 5/02; A01K 7/02

(52) U.S. Cl. CPC A01K 1/0245; A01K 5/0291; A01K 7/02

(57) ABSTRACT

A pet carrier system includes a housing sized to house an animal during a flight and a timer system controlled feeding system able to dispense food and water into the housing to feed the animal at predetermined times. The pet carrier system provides an efficient, safer and soundproof housing that further includes a mechanism that locks with aircraft and allows easy stacking of carriers, allowing aircraft personnel to lock the pet carrier to L-track tie down areas and to other carriers, ensuring they do not tip and fall as easy because they are held better together.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

The present invention relates generally to the field of pet carriers of existing art and more specifically relates to a pet carrier for use specifically in a cargo area of an aircraft.

It is sometimes preferable or necessary to travel with animals, whether relocating, going on an extended vacation, or the like. As such, traveling with animals by air is a common practice. Typically, the procedure involves placing animals in carriers and transporting them in the cargo area of the plane. These pet carriers are typically secured to designated tie-down areas in aircraft cargo holds using L-shaped straps, ensuring the safety and stability of pets during air travel. These L straps are specifically designed to prevent carriers from shifting or tipping over during turbulence or handling.

While this practice is standard and generally considered safe, it is not without its challenges and concerns. One of the notable challenges when traveling with pets in the cargo area of an aircraft is the potential instability of the carriers. While air personnel take precautions to secure these carriers, they can still shift or tip over during turbulence or handling, especially if they are not properly secured within the cargo hold. This instability can be distressing for pets, leading to anxiety and discomfort during the flight. In addition, it can result in the spillage of food and water from the carriers, leaving the animals wet and without sustenance for the duration of the flight, which can be several hours. This is particularly concerning on long-haul journeys, where pets may endure extended periods without access to food or water. Accordingly, a suitable solution is desired.

### SUMMARY OF THE INVENTION

In view of the foregoing disadvantages inherent in the known pet carrier art, the present disclosure provides a novel pet carrier for aircraft. The general purpose of the present disclosure, which will be described subsequently in greater detail, is to provide an improved pet carrier for use specifically in cargo areas of aircraft, particularly commercial aircraft, which secures directly to the aircraft and prevents spillage of food and water in the carrier.

A pet carrier system for use on an aircraft is disclosed herein. According to one or more embodiments of the present invention, the pet carrier system may include a housing, a panel and a feeding system. The housing may include a shell having a front side opposite a rear side, a top side opposite a bottom side, and a pair of opposing side walls all defining an interior space sized to house an animal therein, and an exterior surface opposite an interior surface. The interior surface may include at least one material to soundproof and/or insulate the interior space. The panel may be attached the front side of the housing to provide a window for the interior space.

The feeding system may be disposed within the interior space of the housing and may include a main body, a food section, a water section and a rotating mechanism. The food section may be disposed at a first side of the main body and may include an interior food compartment disposed within the main body, an exterior food dish disposed at a bottom of the main body at an exterior thereof, and a food chute disposed within the main body and connecting the interior food compartment with the exterior food dish. The rotating mechanism may be disposed within the food chute and configured to rotate to dispense a predetermined amount of food into the exterior food dish.

The water section may be disposed at a second side of the main body and including an interior water compartment disposed within the main body, an exterior water dish disposed at the bottom of the main body at the exterior thereof, and a water chute disposed within the main body and connecting the interior water compartment with the exterior water dish.

In some further embodiments, the feeding system may include a food lid and a water lid for covering the food section and the water section, respectively, and at least one lock for locking the food lid and the water lid. Further, the feeding system may include an actuator in communication with the rotating mechanism and configured to actuate rotation thereof, and a timer system in communication with the actuator and configured to activate the actuator at a predetermined time.

According to other embodiments still, a pet carrier system for use on an aircraft may include at least one connector attached to at least one of the rear side, the top side, the bottom side and/or the pair of opposing side walls of the shell. The at least one connector may be configured to engage with an L-track on the aircraft, thereby securing the pet carrier system to the aircraft.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF FIGURES

The figures which accompany the written portion of this specification illustrate embodiments and methods of use for the present disclosure, a pet carrier system for aircraft, constructed and operative according to the teachings of the present disclosure.

FIG. 1 is a front perspective view of a pet carrier system secured in a cargo area of an aircraft, according to an embodiment of the disclosure.

FIG. 2 is a front perspective view of the pet carrier system including a housing having a window, and a feeding system therein, according to an embodiment of the present disclosure.

FIG. 3 is a detailed view of circle 3 in FIG. 2 and illustrating the housing having soundproofing insulation material at an interior surface thereof, according to an embodiment of the present disclosure.

FIG. 4 is a top plan view of the pet carrier system illustrating the feeding system including a lock and a timer system, according to an embodiment of the present disclosure.

FIG. 5 is a front perspective view of the feeding system removed from the housing, the feeding system including a food section and a water section, according to an embodiment of the present disclosure.

FIG. 6 is a front view of the food section of the feeding system having a rotating mechanism to dispense food into an exterior food bowl, according to an embodiment of the present disclosure.

FIG. 7 is a front view of the food section illustrating the rotating mechanism having rotated and dispensed the food into the exterior food bowl, according to an embodiment of the present disclosure.

FIG. 8 is a schematic diagram illustrating software communicating with the pet carrier system, according to an embodiment of the present disclosure.

FIG. 9 is a front perspective view of the pet carrier system including the housing having a liner, a tray and a wheel assembly, according to an alternative embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to pet carriers for aircraft. Generally, the pet carrier is a modern, eco-friendly updated safety carrier system for pets with the extra feature of special locks specifically for aircraft. The pet carrier may include a food and water dispenser which may include a timer system dispenser for food and water; along with soundproof, insulated walls to help decrease some of the intense pressure put on animals during takeoff and landing. In addition, the pet carrier may include a lock mechanism that locks with aircraft and allows easy stacking of carriers in a luggage compartment of the aircraft, allowing aircraft personnel to lock the pet carrier to L-track tie down areas and to other carriers, ensuring they do not tip and fall as easy because they are held better together.

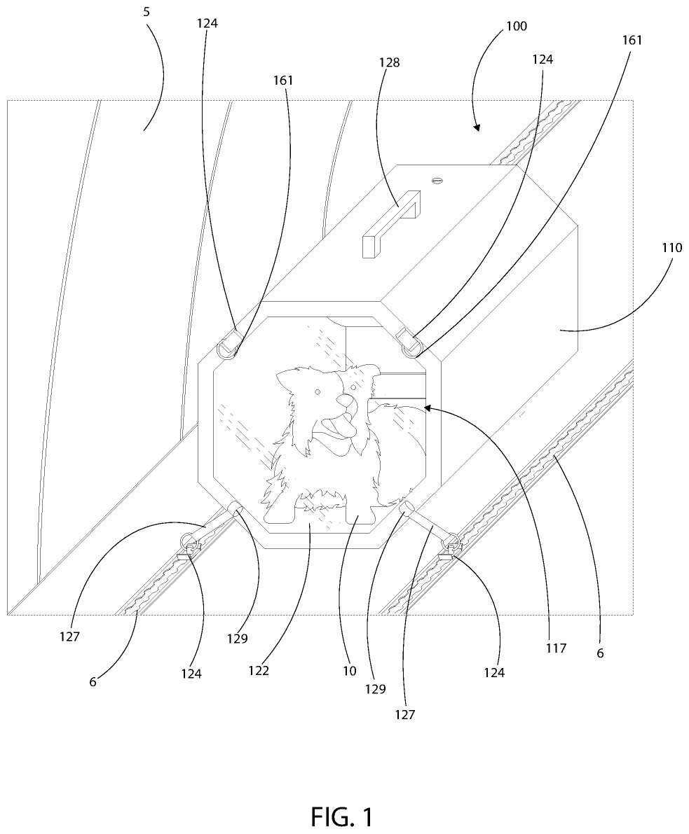

Referring now more specifically to the drawings by numerals of reference, there is shown in FIGS. 1-9, various views of a pet carrier system 100.

Referring first to FIG. 1, there is shown the pet carrier system 100 attached inside a cargo area of an aircraft 5. Particularly, the pet carrier system 100 may be configured to attach to L-track areas located inside the cargo area of the aircraft 5. As such, the pet carrier system 100 may include at least one connector 124 for attaching to an L-track 6 on the aircraft 5. Further, the at least one connector 124 may enable the pet carrier system 100 to attach to, and/or stack with, other pet carriers. As discussed above, this may prevent the pet carrier system 100 from becoming unstable during flight and tipping over and additionally saves time for aircraft 5 personnel in the installation of the pet carrier system 100 on the aircraft 5.

Particularly, as shown here, there may be four connectors 124 each located around a front side 112 of the pet carrier system 100. The four connectors 124 may each include a retractable strap 127, enabling the connectors 124 to be extended from the pet carrier system 100 for use. As shown, the retractable straps 127 may retract from a strap housing 129 attached to the front side 112 of the housing 110. In some embodiments, as shown in FIG. 1, the connectors 124 may each include a ring 161 attached to the retractable strap 127, and an L-track connector end configured to insert into the L-track 6 on the aircraft 5.

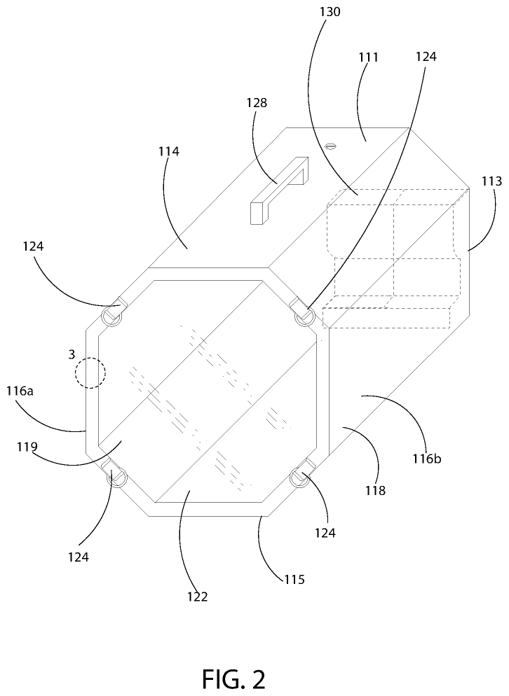

Referring now to FIG. 2, there is shown a front perspective view of the pet carrier system 100 including a housing 110. A feeding system 130 disposed in the housing 110 is shown partially in broken lines to convey that the feeding system 130 is located inside the housing 110. As shown here, the housing 110 may include a shell 111 having the front side 112 opposite a rear side 113, a top side 114 opposite a bottom side 115, and a pair of opposing side walls 116 a, 116 b. In embodiments, a handle 128 may be provided at the top side 114 of the housing 110 to provide portability to the pet carrier system 100.

The shell 111 of the housing 110 may define an interior space 117 sized to house the animal 10 therein. Accordingly, in some embodiments the pet carrier system 100 may be provided in a variety of sizes to accommodate various sizes of animals 10. Further, in some embodiments, the housing 110 may include a honeycomb-like shape. This shape may provide a variety of advantages to the pet carrier system 100. For example, the shape may allow room for layers beneath the animal 10 and may allow more space for the animal 10 to rest comfortably within the housing 110. Further, the shape of the housing 110 may enable the pet carrier system 100 to better fit within the cargo area of the aircraft 5 and enable multiple pet carrier systems 100 to stack and lock into place, thereby offering further stability to and safety to the animal 5.

The shell 111 of the housing 110 may be (but is not limited to being) made from recycled material 121. For example, the shell 111 of the housing 110 may include plant-based biopolymer. In another example, the shell 111 of the housing 110 may include plant-flax straw fibers. It should however be appreciated that the shell 111 is not limited to either of these materials.

A panel 122 may be attached to the front side 112 of the housing 110. In some embodiments, the panel 122 may include smart glass (or a material other than glass) that allows the panel 122 to alter between opaque and transparent. The panel 122 may provide a window for the housing 110, allowing light and air into the housing 110.

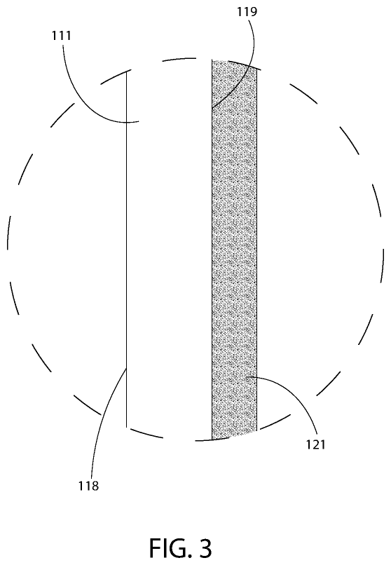

Referring now also to FIG. 3, with reference still to FIG. 2, there is shown a detailed view of the housing 110 taken from circle 3 in FIG. 2. As shown here, the shell 111 may further include an exterior surface 118 opposite an interior surface 119. The interior surface 119 may include at least one material 121 to soundproof and/or insulate the interior space 117. For example, the interior surface 119 of the housing 110 may be insulated to decrease pressure within the housing 110 experienced during flight, particularly during takeoff and landing. In some examples, the at least one material 121 may include a blend of organic fibers. For example, the material 121 may utilize a blend of organic cotton and cellulose fibers, such as (but not limited to) ECO-C-TEX®. Again, it should be appreciated that the material 121 is not limited to any materials discussed here. Further, the texture for the material 121 shown in FIG. 3 is for illustrative purposes only and does not limit the material 121 in any way.

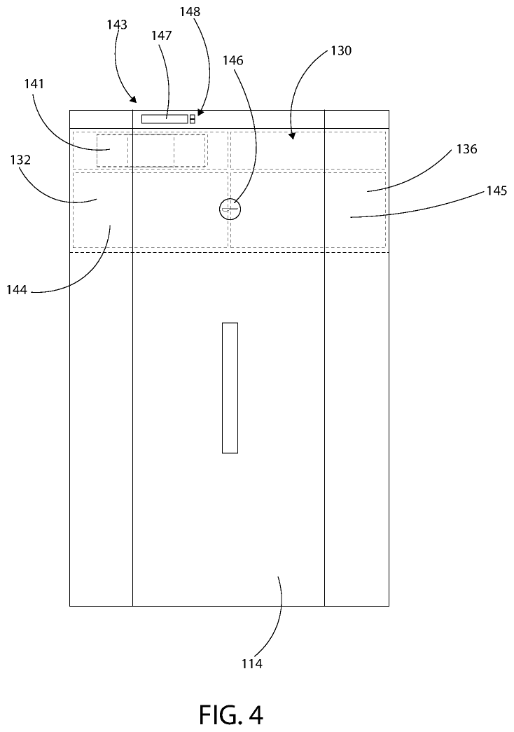

Referring now to FIGS. 4-7, there are shown various views of a feeding system 130 provided as part of the pet carrier system 100, according to one or more embodiments of the present disclosure. Throughout these figures, many elements are illustrated in broken lines only to convey that the elements are located within another element—the broken lines are not meant to limit the invention or exclude any elements in any way. The feeding system 130 may be particularly useful for ensuring that food and water is not tipped over, thus preventing the animal 10 from becoming soiled and/or left for prolonged periods with no food or water.

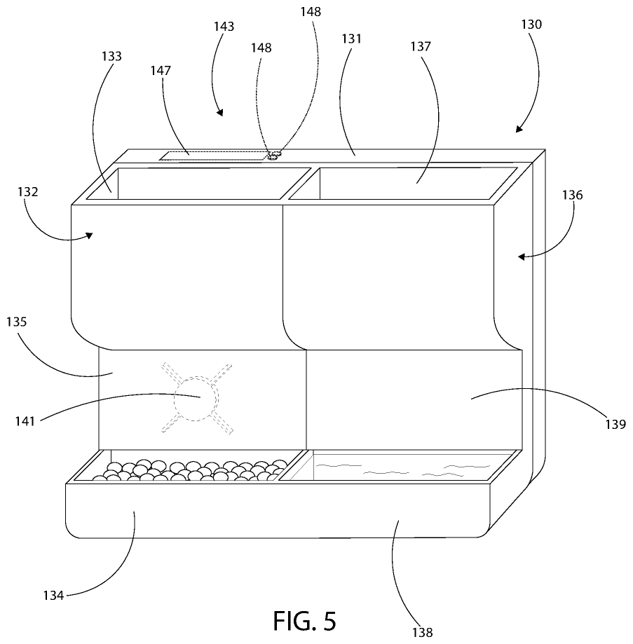

As shown in FIG. 4, the feeding system 130 may be disposed within the interior space 117 of the housing 110. In some embodiments, the feeding system 130 may be removable from the housing 110. FIG. 5 illustrates the feeding system 130 having been removed from the housing to better illustrate the feeding system 130. As demonstrated here, the feeding system 130 may include a main body 131, a food section 132, a water section 136 and a rotating mechanism 141. The food section 132 may include an interior food compartment 133 disposed within the main body 131. The interior food compartment 133 may be filled by an owner with an appropriate amount of food. For example, the interior food compartment 133 may be filled with an amount of food that would be eaten by the animal 10 during the allotted flight time.

A food chute, or passageway, 135 disposed within the main body 131 may connect the interior food compartment 133 to an exterior food dish 134 disposed at a bottom of the main body 131 at an exterior thereof. The exterior food dish 134 is the portion of the feeding system 130 that the animal 10 is able to access to retrieve their food. As such, the exterior food dish 134 may be sized to house a portion of the amount of food stored in the interior food compartment 133. Storing only a portion of the food may prevent the animal 10 from going without food during the entire flight should the food in the exterior food dish 134 spill.

The water section 136 may include an interior water compartment 137 disposed within the main body 131, an exterior water dish 138 disposed at the bottom of the main body 131 at the exterior thereof, and an interior water chute, or passageway 139, disposed within the main body 131 and connecting the interior water compartment 137 with the exterior water dish 138. Similar to the food section 132, the interior water compartment 137 may store the amount of water needed for the entirety of the flight. The exterior water dish 138 may store a portion of the amount of water. Similar to the food section 132, storing just a portion of the water may prevent the animal 10 from not having access to water during the entire flight should the water spill. As such, a mechanism (not illustrated) may be provided within the water chute 139 to fill the exterior water dish 138 (i.e., let water pass from the interior water compartment 137 into the exterior water dish 138) as it becomes empty, or at a particular fill level.

In some embodiments, the food section 132 and the water section 136 may include gravity mechanisms (not illustrated), preventing food and/or water from being spilled when the pet carrier system 100 is moving. For example, the food dish 134 and the water dish 138 may each include a gyro bowl.

As shown in FIG. 4, the feeding system 130 may further comprise a food lid 144 selectively covering the interior food compartment 133, and a water lid 145 selectively covering the interior water compartment 137. The feeding system 130 may further comprise at least one lock 146 for locking the food lid 144 and the water lid 145. Accordingly, at least one key (not illustrated) may be provided for locking and unlocking the at least one lock 146. This may prevent the food and water stored in the interior food compartment 133 and the interior water compartment 137, respectively, from spilling out of the feeding system 130 if the pet carrier system 100 falls.

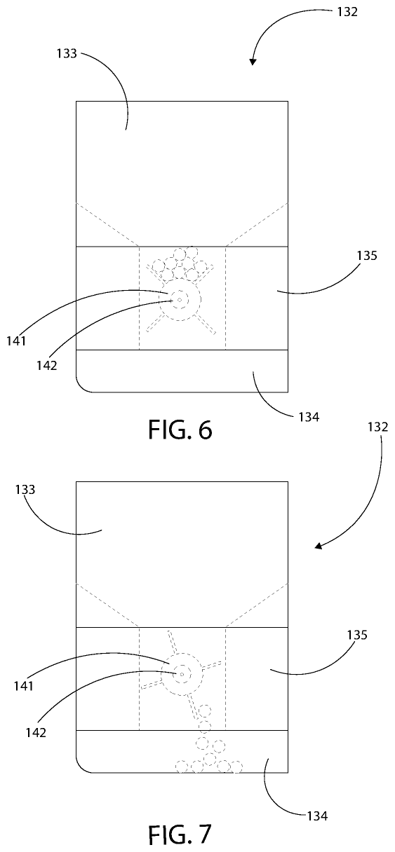

As shown in FIG. 5, and more particularly in FIGS. 6-7 (again via broken lines), the rotating mechanism 141 may be in communication with the food chute 135 and configured to rotate to dispense a predetermined amount of food from the interior food compartment 133 and into the exterior food dish 134. Particularly, the rotating mechanism 141 may be located within the food chute 135. FIGS. 6-7 demonstrate the rotating mechanism 141 rotating to dispense the predetermined amount of food into the exterior food dish 134.

Further, in some embodiments, the feeding system 130 may comprise an automatic dispensing system able to automatically dispense food and water at predetermined times. The automatic dispensing system may include an actuator 142 (FIGS. 6-7) in communication with the rotating mechanism 141 and configured to actuate rotation thereof, and a timer system 143 (FIGS. 4-5) in communication with the actuator 142 and configured to activate the actuator 142 at a predetermined time. For example, for an eight hour flight, the automatic dispensing system may be configured to dispense a quarter of a cup of food every two hours. As shown in FIGS. 4-5, in some embodiments, the timer system 143 may include timer system controls, such as (but not limited to) a display 147 and/or one or more buttons 148, enabling an owner to manually set the timer system 143.

In some examples, the actuator 142 may include a motor, a solenoid or the like. For example, as shown in FIGS. 6-7, a motor may be attached to a center of the rotating mechanism 141 and configured to rotate the rotating mechanism 141 upon activation by the timer system 143. The automatic dispensing system may include simple processes for automatically dispensing food, for example, a simple circuit may be used to trigger the rotating mechanism 141 at predetermined times. In other examples, the automatic dispensing system may include a more sophisticated process, including a microcontroller or processor.

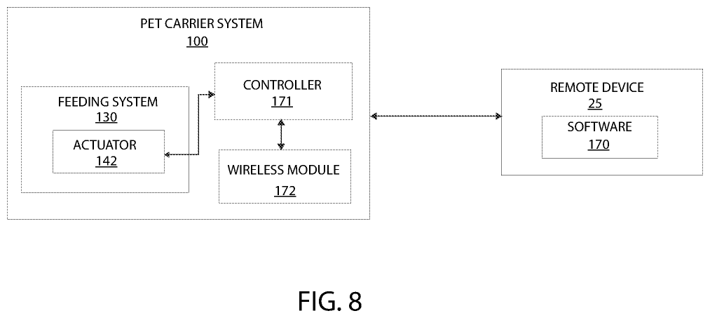

Referring now to FIG. 8, in some embodiments, a software application 170 may be provided for use on a remote device 25 and configured to communicate with the feeding system 130. For example, the software application may include a smartphone application useable on a smartphone. In this embodiment, the pet carrier system 100 may include a controller 171, such as a microprocessor, and a wireless communication module 172 configured to communicate with the software application 170. The software application 170 may enable the owner to remotely feed the animal 10 in the pet carrier system 100. As such, upon actuation via the software application 170, the software application 170 may send a signal to the controller 171, which upon receipt of the signal, is configured to actuate the actuator 142 to dispense the food.

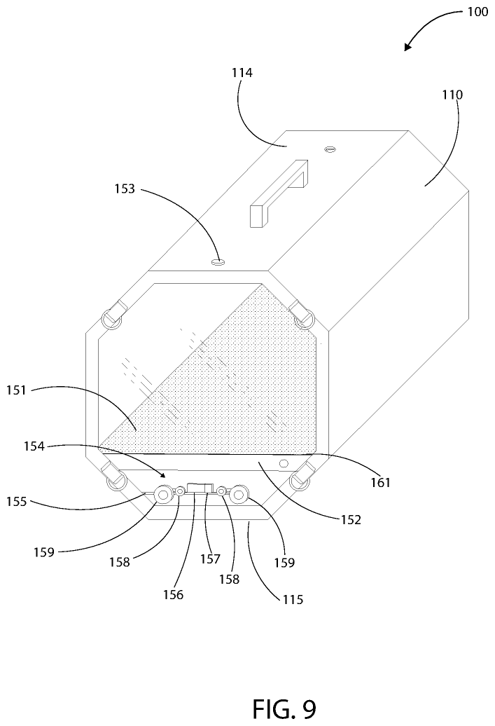

Referring now to FIG. 9, there is shown a front perspective view of an alternative embodiment of the present disclosure. Particularly, as shown here, the pet carrier system 100 may include the housing 110, a liner 151 removably positioned at a bottom floor of the housing 110, a tray 152 underneath the liner 151, and a wheel assembly 154. In some embodiments, the liner 151 may be made of an absorbing leakproof material. Further, located underneath the liner 151 and atop the tray 152 may be a support platform 161 having a plurality of holes therein (not illustrated) for allowing liquids therethrough. The tray 152 may be configured to be pulled out from the housing 110 and may include one or more liners 151 therein. Further, the tray 152 may include odor absorbing beads therein (not illustrated) for absorbing any odors from the liquids passing through the support platform 161.

The wheel assembly 154 may be located toward the bottom side 115 of the housing 110 and may be in communication with a button 153 located at the top side 114 of the housing 110, which enables actuation of the wheel assembly 154. The wheel assembly 154 may include a rod 155, a motor 156 connected to the rod 155, a battery 157 supplying power to the motor 156, one or more wheel arms 158 attached to the rod 155 and one or more wheels 159. In some examples, one wheel 159 may be attached to two arms 158: one to hold the wheel 159 in place and allow for slight forward motion and another attached to the rod 155 that will simultaneously push forward or back allowing the wheels 159 to be exposed or retracted for storing.

Upon actuation of the wheel assembly 154 (via the button 153), the motor 156 may move the rod 155, moving the wheel arm(s) 158 and in turn moving the wheel(s) 159 between a retracted position and an exposed position. In the retracted position, the wheel assembly 154 is stowed within the housing 110; and in the exposed position, the wheel assembly 154 protrudes through the bottom side 115 of the housing 110 and is used to transport the pet carrier system 100.

It should be noted that, under appropriate circumstances, considering such issues as design preference, user preferences, marketing preferences, cost, structural requirements, available materials, technological advances, etc., other methods are taught herein.

It should be understood by one of skill in the art that the disclosed invention is described here in a few exemplary embodiments of many. No particular terminology or description should be considered limiting on the disclosure or the scope of any claims issuing therefrom.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the relevant patent office(s) and the public generally, and especially the scientist, engineers and practitioners in the art who are not familiar with patent or legal terms or phraseology, to determine quickly from a cursory inspection the nature and essence of the technical disclosure of the application.

1. A pet carrier system for use on an aircraft, the pet carrier system comprising:
a housing including a shell having a front side opposite a rear side, a top side opposite a bottom side, and a pair of opposing side walls all defining an interior space sized to house an animal therein, the shell further including an exterior surface opposite an interior surface, wherein the interior surface includes at least one material to at least one of soundproof and insulate the interior space;
a panel attached at the front side of the housing and providing a window for the interior space; and
a feeding system disposed within the interior space of the housing, the feeding system including:
a main body;
a food section at a first side of the main body, the food section having an interior food compartment disposed within the main body, an exterior food dish disposed at a bottom of the main body at an exterior thereof, and a food chute disposed within the main body and connecting the interior food compartment with the exterior food dish;
a rotating mechanism disposed within the food chute and configured to rotate to dispense a predetermined amount of food from the interior food compartment into the exterior food dish; and
a water section at a second side of the main body, the water section having an interior water compartment disposed within the main body, an exterior water dish disposed at the bottom of the main body at the exterior thereof, and a water chute disposed within the main body and connecting the interior water compartment with the exterior water dish.

2. The pet carrier system of claim 1, wherein the feeding system further includes an automatic dispensing system including an actuator in communication with the rotating mechanism configured to actuate rotation thereof, and a timer system in communication with the actuator and configured to activate the actuator at a predetermined time.

3. The pet carrier system of claim 2, wherein the feeding system is removable from the housing.

4. The pet carrier system of claim 3, wherein the feeding system further comprises a food lid selectively covering the interior food compartment, a water lid selectively covering the interior water compartment and at least one lock for locking the food lid and the water lid.

5. The pet carrier system of claim 4, further comprising:
software running on a remote device;
a wireless communication module coupled to the housing configured for communication with the software;
a controller coupled to the housing, the controller in communication with the actuator and the wireless communication module; and
wherein a user is able to actuate the automatic dispensing system via the software on the remote device.

6. The pet carrier system of claim 1, wherein the at least one material includes a blend of organic fibers.

7. The pet carrier system of claim 6, wherein the shell of the housing includes plant-based biopolymer.

8. The pet carrier system of claim 6, wherein the shell of the housing includes flax straw fibers.

9. The pet carrier system of claim 1, further comprising at least one connector attached to at least one of the rear side, the top side, the bottom side and the pair of opposing side walls, and wherein the at least one connector is configured to attach to an L-track on the aircraft.

10. The pet carrier system of claim 9, wherein the at least one connector includes a retractable strap.

11. A pet carrier system for use on an aircraft, the pet carrier system comprising:
a housing including a shell having a front side opposite a rear side, a top side opposite a bottom side, and a pair of opposing side walls all defining an interior space sized to house an animal therein, the shell further including an exterior surface opposite an interior surface, wherein the interior surface includes at least one material to soundproof and insulate the interior space;
a panel attached the front side of the housing and providing a window for the interior space; and
an automatic feeding system disposed within the interior space of the housing, the feeding system including:
a main body;
a food section at a first side of the main body, the food section having an interior food compartment disposed within the main body, an exterior food dish disposed at a bottom of the main body at an exterior thereof, and a food chute disposed within the main body and connecting the interior food compartment with the exterior food dish and a food lid selectively covering the interior food compartment;
a water section at a second side of the main body, the water section having an interior water compartment disposed within the main body, an exterior water dish disposed at the bottom of the main body at the exterior thereof, and an interior water chute disposed within the main body and connecting the interior water compartment with the exterior water dish and a water lid selectively covering the interior water compartment;
at least one lock for locking the food lid and the water lid;
a rotating mechanism disposed within the food chute and configured to rotate to dispense a predetermined amount of food into the exterior food dish;
an actuator in communication with the rotating mechanism and configured to actuate rotation thereof; and
a timer system in communication with the actuator and configured to activate the actuator at a predetermined time.

12. The pet carrier system of claim 11, further comprising:
software running on a remote device;
a wireless communication module coupled to the housing configured for communication with the software;
a controller coupled to the housing, the controller in communication with the actuator and the wireless communication module; and
wherein a user is able to actuate the automatic dispensing system via the software on the remote device.

13. The pet carrier system of claim 11, wherein the at least one material includes a blend of organic fibers.

14. The pet carrier system of claim 11, wherein the shell of the housing includes plant-based biopolymer.

15. The pet carrier system of claim 11, wherein the shell of the housing includes flax straw fibers.

16. The pet carrier system of claim 11, further comprising at least one connector attached to at least one of the rear side, the top side, the bottom side and the pair of opposing side walls;
wherein the at least one connector includes a retractable strap; and
wherein the at least one connector is configured to attach to an L-track on the aircraft.

17. A pet carrier system for use on an aircraft, the aircraft including at least one L-track, the pet carrier system comprising:
a housing including a shell having a front side opposite a rear side, a top side opposite a bottom side, and a pair of opposing side walls all defining an interior space sized to house an animal therein, the shell further including an exterior surface opposite an interior surface, wherein the interior surface includes at least one material to soundproof and insulate the interior space;
a panel attached the front side of the housing and providing a window for the interior space;
at least one retractable connector attached to at least one of the rear side, the top side, the bottom side and the pair of opposing side walls, the at least one retractable connector configured to attach to the at least one L-track, thereby securing the pet carrier system to the aircraft;
an automatic feeding system removably disposed within the interior space of the housing, the feeding system including:
a main body;
a food section at a first side of the main body, the food section having an interior food compartment disposed within the main body, an exterior food dish disposed at a bottom of the main body at an exterior thereof, and a food chute disposed within the main body and connecting the interior food compartment with the exterior food dish and a food lid selectively covering the interior food compartment;
a water section at a second side of the main body, the water section having an interior water compartment disposed within the main body, an exterior water dish disposed at the bottom of the main body at the exterior thereof, and an interior water chute disposed within the main body and connecting the interior water compartment with the exterior water dish and a water lid selectively covering the interior water compartment;
at least one lock for locking the food lid and the water lid;
a rotating mechanism in communication with the food chute and configured to rotate to dispense a predetermined amount of food from the interior food compartment and into the exterior food dish;
an actuator in communication with the rotating mechanism and configured to actuate rotation thereof; and
a timer system in communication with the actuator and configured to activate the actuator at a predetermined time;
software running on a remote device;
a wireless communication module coupled to the housing configured for communication with the software; and
a controller coupled to the housing, the controller in communication with the actuator and the wireless communication module; and
wherein a user is able to actuate the automatic dispensing system via the software on the remote device.

18. The pet carrier system of claim 17, wherein the at least one material includes a blend of organic fibers.

19. The pet carrier system of claim 17, wherein the shell of the housing includes plant-based biopolymer.

20. The pet carrier system of claim 17, wherein the shell of the housing includes flax straw fibers.
